(19) United States
(12) Patent Application Publication
(10) Pub. No.: US 2026/0078022 A1
(43) Pub. Date: Mar. 19, 2026

(54) OCEAN VOLUME REDUCTION APPARATUS

(71) Applicant: Zehra Ali, Milton (CA)

(72) Inventor: Zehra Ali, Milton (CA)

(21) Appl. No.: 18/889,882

(22) Filed: Sep. 19, 2024

(51) Int. Cl. C02F 1/04; C02F 1/28; C02F 103/08

(52) U.S. Cl. CPC C02F 1/043; C02F 1/28; C02F 2103/08; C02F 2201/007; C02F 2201/008

(57) ABSTRACT

A water reduction apparatus that is configured to be placed in a marine environment and reduce the water level therein through transfer of the water from the ocean to misting discharge nozzles operable to enable evaporation of the water. The apparatus includes a body wherein the body has a first layer and a second layer integrally formed. The first layer is manufactured from a buoyant material and has an upper surface constructed to resemble an iceberg. The second layer is manufactured from an absorbent material operable to absorb the water in which the body is disposed. A pump is operably coupled to a plurality of discharge nozzles and is configured to transfer water present in the second layer to the discharge nozzles to facilitate evaporation thereof. The apparatus further includes a propulsion member for moving the body and a plurality of pressure sensors for detecting animals on the upper surface.

### FIELD OF THE INVENTION

The present invention relates generally to climate change and control of negative effects thereof, more specifically but not by way of limitation, an apparatus operable to provide reduction of the volume of water in the oceans resulting from melting polar caps wherein the present invention provides absorption of the water in the ocean and further redistributes to facilitate the evaporation thereof.

### BACKGROUND

Global average sea level has risen approximately eight inches since 1880. In 2022, global average sea level set a new record high which was four inches above the record 1993 levels. The rate of global sea level rise is accelerating and it has more than doubled from 0.06 inches per year throughout most of the twentieth century to 0.14 inches per year from 2006-2015. In many locations along the North American coastline, the rate of local sea level rise is greater than the global average due to land processes like erosion, soil and groundwater pumping, and subsidence. High-tide flooding is now significantly more frequent than it was fifty years ago. In some ocean basins, sea level has risen as much as six to eight inches since the start of the satellite record. Regional differences exist because of natural variability in the strength of winds and ocean currents, which influence how much and where the deeper layers of the ocean store heat.

Past and future sea level rise at various locations on land may be more or less than the global average due to local factors: ground settling, upstream flood control, erosion, regional ocean currents, and whether the land is still rebounding from the compressive weight of Ice Age glaciers. In the United States, the fastest rates of sea level rise are occurring in the Gulf of Mexico from the mouth of the Mississippi westward, followed by the mid-Atlantic. Only in Alaska and a few places in the Pacific Northwest are sea levels falling, though that trend may reverse under high greenhouse gas emissions.

The global sea level is very important and its change has the potential to be very impactful. In North America, almost thirty percent of the population lives in relatively high population-density coastal areas, where sea level plays a role in flooding, shoreline erosion, and hazards from storms. Globally, eight of the world's ten largest cities are near a coast. Global warming is causing global mean sea level to rise in two ways. First, glaciers and ice sheets worldwide are melting and adding water to the ocean. Second, the volume of the ocean is expanding as the water warms. A third, much smaller contributor to sea level rise is a decline in the amount of liquid water on land—aquifers, lakes and reservoirs, rivers, soil moisture. This shift of liquid water from land to ocean is largely due to people depleting ground water.

Accordingly, there is a need for an apparatus that can be deployed into the oceans wherein the apparatus will provide absorption of the water in the ocean and further facilitate evaporation thereof so as to provide a reduction in the sea level in a region wherein the present invention is deployed.

### SUMMARY OF THE INVENTION

It is the object of the present invention to provide an apparatus configured to be deployed into the ocean and operable to provide reduction in the sea level in the region proximate thereto wherein the present invention includes a body, said body configured to be buoyant.

Another object of the present invention is to provide a water level reducing device that is configured to absorb and evaporate water in which the device is floating wherein the body of the present invention includes a top layer and a bottom layer integrally formed wherein the bottom layer is manufactured from an absorbent material.

A further object of the present invention is to provide an apparatus configured to be deployed into the ocean and operable to provide reduction in the sea level in the region proximate thereto wherein the top layer of the body is manufactured from a buoyant material and remains above the water level in which the body is disposed.

Yet a further object of the present invention is to provide a water level reducing device that is configured to absorb and evaporate water in which the device is floating wherein the body of the present invention further includes an evaporation assembly that includes at least one pump and a plurality of misting sprinklers.

Still another object of the present invention is to provide an apparatus configured to be deployed into the ocean and operable to provide reduction in the sea level in the region proximate thereto wherein the present invention includes a controller having the necessary electronics to receive, store, transmit and manipulate data.

An additional object of the present invention is to provide a water level reducing device that is configured to absorb and evaporate water in which the device is floating wherein the present invention further includes photovoltaic cell panels operable to provide electricity for operation of the present invention.

Yet a further object of the present invention is to provide an apparatus configured to be deployed into the ocean and operable to provide reduction in the sea level in the region proximate thereto wherein the present invention further includes a propulsion member configured to provide movement of the body.

Still a further object of the present invention is to provide a water level reducing device that is configured to absorb and evaporate water in which the device is floating wherein the bottom layer of the body includes water saturation detection sensors.

An additional object of the present invention is to provide an apparatus configured to be deployed into the ocean and operable to provide reduction in the sea level in the region proximate thereto wherein the top layer includes a multitude of pressure sensors configured to detect a presence of a marine mammal thereon.

Yet another object of the present invention is to provide a water level reducing device that is configured to absorb and evaporate water in which the device is floating wherein the present invention includes a geolocation module.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a cross-sectional diagrammatic view of the present invention; and

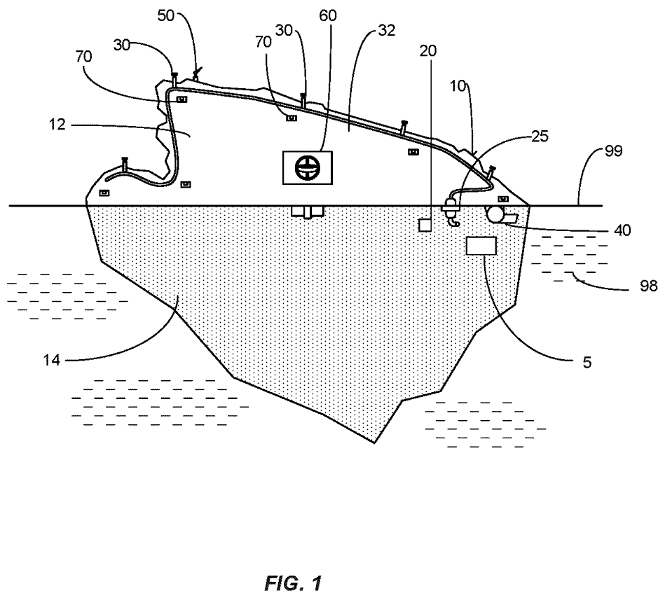

FIG. 2 is a top perspective view of the present invention disposed in a marine environment.

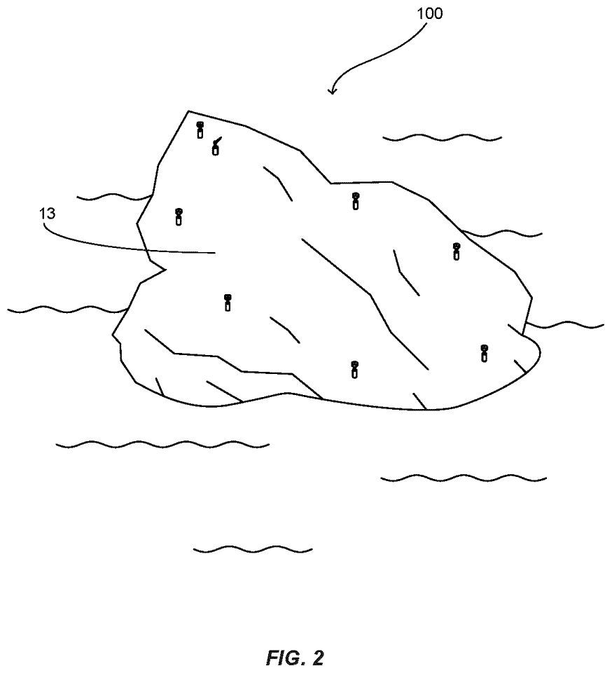

### DETAILED DESCRIPTION

Referring now to the drawings submitted herewith, wherein various elements depicted therein are not necessarily drawn to scale and wherein through the views and figures like elements are referenced with identical reference numerals, there is illustrated a water reduction apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the water reduction apparatus 100 is operable to be deployed in marine environments wherein the present invention is configured to provide reduction of the water level in the marine environment in which it is disposed. It should be understood within the scope of the present invention that the water reduction apparatus 100 could be placed either solely or in combination with additional water reduction apparatus 100 in order to achieve the desired result of reducing the water volume in the marine environment in which the water reduction apparatus 100 is disposed.

The water reduction apparatus 100 includes a body 10. The body 10 is comprised of a first layer 12 and a second layer 14 that are integrally formed utilizing suitable durable techniques. The first layer 12 of the body 10 is manufactured from a durable buoyant biodegradable material such as but not limited to biodegradable plastic. It should be understood within the scope of the present invention that the body 10 could be provided in various alternate sizes to include sizes up to several hundred square meters. The first layer 12 of the body 10 has an upper surface 13 that includes features so as to resemble an iceberg. These features can include but are not limited to undulations, cracks and crevices.

The second layer 14 of the body 10 is located beneath the marine layer 99 so as to be fully immersed in water 98. The second layer 14 is manufactured from an absorbent material so as to provide absorption and retention of the water 98 in which the body 10 is disposed. It should be understood within the scope of the present invention that the second layer 14 could be manufactured from various absorbent materials such as but not limited to superabsorbent polymer. The second layer 14 has mounted therein a water saturation sensor 20. The water saturation sensor 20 is proximate the top of the second layer 14 and is configured to provide detection of the water content within the second layer 14. The water saturation sensor 20 is operably coupled to the controller 5 and the pump module 25. Controller 5 is operably coupled to all of the elements of the present invention and includes the necessary electronics so as to receive, store, transmit and manipulate data. The controller 5 receives a signal from the water saturation sensor 20 upon the material of the second layer 14 reaching its maximum water content. Ensuing receipt of the signal from the water saturation sensor 20, the controller 5 transmits a signal to the pump module 25. Pump module 25 is a water pump that is operably coupled to a plurality of misting discharge nozzles 30 via tubing 32 mounted across the first layer 12. The pump module 25 is configured to extract water from the second layer 15 and transfer to the misting discharge nozzles 30. The discharge of the water in a mist format provides evaporation of the water. The pump module 25 removes the water from the second layer 14 and is transitioned to its off position by the controller 5. It should be understood within the scope of the present invention that the water reduction apparatus 100 could include more than one pump module 25 placed in alternate locations within the second layer 14.

The water reduction apparatus 100 further includes a propulsion member 40. The propulsion member 40 is operable to provide movement of the water reduction apparatus 100 in the event a user thereof determines movement provided by natural water currents is undesirable. The propulsion member 40 is operably coupled to the controller 5 and it should be understood within the scope of the present invention that the propulsion member 40 could be embodied in alternate embodiments so as to achieve the desired objective discussed herein. By way of example but not limitation, the propulsion member 40 could be embodied as an impeller. The water reduction apparatus 100 further includes a geolocation module 50. The geolocation module 50 is communicably coupled to the controller 5 and is operable to transmit geolocation signals thereto. The geolocation module 50 is further configured to transmit geolocation to remote users providing location information to the remote user. A photovoltaic panel 60 is mounted in the first layer 12 of the body 10. The photovoltaic panel 60 is operably coupled to the controller 5, pump module 25 and propulsion member 40 providing electrical current thereto to sustain the operation of the aforementioned elements.

The water reduction apparatus 100 includes a plurality of pressure sensors 70 mounted beneath the upper surface 13 of the first layer 12. The pressure sensors 70 are configured to detect weight applied thereto. By way of example but not limitation, the pressure sensors 70 are operable to detect the presence of a marine mammal disposed on the upper surface 13. The pressure sensors 70 are operably coupled to the controller 5 wherein the pressure sensors 70 transmit a signal to the controller 5 ensuing detection of pressure thereon. Pressure data is transmitted by the controller 5 to a remote user wherein the remote user can execute tasks or inhibit execution of tasks during the presence of a marine mammal. By way of example but not limitation, the remote user could activate the propulsion member 40 in order to assist in transport of the marine mammal to a desired location.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A water reduction apparatus that is configured to be disposed in an ocean and provide reduction of water level thereof wherein the water reduction apparatus comprises:
a body, said body having a first layer and a second layer, said first layer of said body being manufactured from a buoyant material, said first layer and said second layer being integrally formed, said first layer having an upper surface, said first layer being substantially above a waterline of water in which the body has been disposed, said second layer being manufactured from an absorbent material, said second layer being beneath said first layer, said second layer being beneath said waterline of the water, said second layer operable to absorb water surroundably present thereto;
a pump module, said pump module being mounted in said second layer of said body, said pump module being operably coupled to a water saturation sensor, said pump module configured to evacuate water from said second layer ensuing receipt of a signal from said water saturation sensor;
a plurality of discharge nozzles, said plurality of discharge nozzles being operably coupled to said pump module via tubing, said plurality of discharge nozzles configured to receive water from said pump module and provide discharge thereof to facilitate evaporation of the water, said plurality of discharge nozzles being mounted on the upper surface of said first layer; and
a controller, said controller having electronics configured to receive, store, transmit and manipulate data, said controller configured to provide operation of the water reduction apparatus.

2. The water reduction apparatus that is configured to be disposed in an ocean and provide reduction of the water level as recited in claim 1, and further including a propulsion member, said propulsion member operably coupled to said controller, said propulsion member configured to move said body in the ocean.

3. The water reduction apparatus that is configured to be disposed in an ocean and provide reduction of the water level as recited in claim 2, and further including a geolocation module, said geolocation module being mounted to the upper surface of said first layer, said geolocation module operably coupled to said controller, said geolocation module operable to provide geolocation information of said body.

4. The water reduction apparatus that is configured to be disposed in an ocean and provide reduction of the water level as recited in claim 3, and further including a plurality of pressure sensors, said plurality of pressure sensors being mounted underneath the upper surface of said first layer, said plurality of pressure sensors operably coupled to said controller, said plurality of pressure sensors configured to detect a presence of an animal on the upper surface.

5. The water reduction apparatus that is configured to be disposed in an ocean and provide reduction of the water level as recited in claim 4, and further including at least one photovoltaic panel, said photovoltaic panel operable to provide electrical current needed to operate the water reduction apparatus.

6. The water reduction apparatus that is configured to be disposed in an ocean and provide reduction of the water level as recited in claim 5, wherein the second layer is manufactured from a superabsorbent polymer.

7. The water reduction apparatus that is configured to be disposed in an ocean and provide reduction of the water level as recited in claim 6, wherein the upper surface is constructed to resemble an iceberg.
